(19) United States
(12) Patent Application Publication
(10) Pub. No.: US 2023/0323120 A1
(43) Pub. Date: Oct. 12, 2023

(54) POLY (PHENYLENE SULFIDE) RESIN COMPOSITION AND VIBRATION DAMPING MATERIAL INCLUDING SAME

(71) Applicant: Kureha Corporation, Tokyo (JP)

(72) Inventors: Daisuke MURANO, Tokyo (JP); Haruki MOKUDAI, Tokyo (JP); Yoshinori SUZUKI, Tokyo (JP)

(73) Assignee: Kureha Corporation, Tokyo (JP)

(21) Appl. No.: 18/040,233

(22) PCT Filed: Jul. 15, 2021
(86) PCT No.: PCT/JP2021/026619

§ 371 Date: Feb. 1, 2023

(30) Foreign Application Priority Data
Aug. 6, 2020 (JP) 2020-133844

(51) Int. Cl. C08L 81/02

(52) U.S. Cl. CPC C08L 81/02

(57) ABSTRACT

A poly(phenylene sulfide) resin composition having high loss factors at 50° C. or higher and 100° C. or lower is provided. The poly(phenylene sulfide) resin composition contains poly(p-phenylene sulfide) and poly(m-phenylene sulfide).

### TECHNICAL FIELD

The present invention relates to a poly(phenylene sulfide) resin composition and a vibration damping material containing the poly(phenylene sulfide) resin composition.

### BACKGROUND ART

In recent years, many electric vehicles have been developed. For electric vehicles, compared to typical automobiles, higher quietness is demanded for the inside of vehicles during driving. Thus, to enhance the quietness inside of vehicles, imparting of vibration-damping properties to components in vehicles has been studied.

Poly(phenylene sulfide) (hereinafter, also referred to as “PPS”) has been widely used as a raw material for a component for an automobile because the poly(phenylene sulfide) has excellent heat resistance and chemical resistance. Use of PPS as the vibration damping material has been thus considered. However, although PPS has a high loss factor at a relatively high temperature (e.g., higher than 100° C.), the PPS has a low loss factor at 100° C. or lower. Therefore, it has been difficult to use PPS as a vibration damping material in an environment at 100° C. or lower, which is a problem.

Meanwhile, to further enhance processability, heat resistance, and dimensional stability of PPS, various methods of adding a thermoplastic resin or an elastomer resin to PPS have been proposed (e.g., Patent Document 1 and Patent Document 2).

### CITATION LIST

### Patent Literature

Patent Document 1: JP 2016-147960 A
Patent Document 2: JP 2018-035230 A

### SUMMARY OF INVENTION

### Technical Problem

However, it is difficult to achieve a high loss factor at 100° C. or lower of a resin composition even when a thermoplastic resin and/or an elastomer resin are mixed with PPS like Patent Document 1 and Patent Document 2. Thus, as used to be, a resin composition having high vibration damping properties at 100° C. or lower is demanded.

In response to the above issue, an object of the present invention is to provide a poly(phenylene sulfide) resin composition having high loss factors at 50° C. or higher and 100° C. or lower, and a vibration damping material containing the poly(phenylene sulfide) resin composition.

### Solution to Problem

An embodiment of the present invention provides a poly(phenylene sulfide) resin composition described below:

The poly(phenylene sulfide) resin composition containing poly(p-phenylene sulfide) and poly(m-phenylene sulfide).

The present invention also provides a vibration damping material described below:

The vibration damping material containing the poly(phenylene sulfide) resin composition described above.

The present invention also provides a molded article described below: The molded article containing the poly(phenylene sulfide) resin composition described above or the vibration damping material described above.

### Advantageous Effects of Invention

The poly(phenylene sulfide) resin composition according to an aspect of the present invention has high loss factors at 50° C. or higher and 100° C. or lower. Thus, the poly(phenylene sulfide) resin composition can be used as a vibration damping material in an environment in this temperature range.

### DESCRIPTION OF EMBODIMENTS

In the present specification, numerical ranges indicated by “to” refer to numerical ranges including the numerical values described before and after “to”.

An embodiment of the present invention relates to a poly(phenylene sulfide) resin composition (hereinafter, also simply referred to as “resin composition”) that can be used as a vibration damping material and the like. However, use of the resin composition is not limited to this use.

The loss factor in the present specification is a loss elastic modulus (E″) with respect to a storage elastic modulus (E′) of a resin or resin composition. Specifically, the loss factor is a value expressed by loss elastic modulus (E″)/storage elastic modulus (E′). The loss factor is a value expressing an energy absorption amount of a resin when the resin or resin composition is deformed. That is, a higher loss factor indicates higher vibration damping properties.

By the diligent study, the present inventors have found that a resin composition has high loss factors at 50° C. or higher and 100° C. or lower when the resin composition contains a combination of a poly(p-phenylene sulfide) (hereinafter, also referred to as “p-PPS”) and a poly(m-phenylene sulfide) (hereinafter, also referred to as “m-PPS”). The reason for this is thought to be as follows.

The p-PPS has a structure with a relatively high crystallinity. Thus, the p-PPS has excellent heat resistance, moldability, and the like, but has low flexibility. Meanwhile, the m-PPS is relatively flexible but has low moldability and the like. When such p-PPS and m-PPS coexist, the m-PPS easily gets into crystals of the p-PPS because the p-PPS and the m-PPS have similar structures. As a result, the loss elastic modulus of the resin composition is high even at 100° C. or lower (e.g., 50° C. or higher and 100° C. or lower). Furthermore, because the structures of the p-PPS and the m-PPS are similar, the resin composition has a high loss factor at the temperature described above without remarkably impairing the heat resistance or moldability originated from the p-PPS.

The p-PPS and the m-PPS will be described in detail below.

### Poly(p-Phenylene Sulfide) (p-PPS)

The p-PPS is a resin containing a structural unit represented by Formula (1) below.

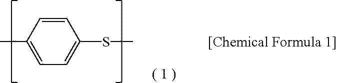

In a range that does not impair the desired effects, the p-PPS may partially contain a structural unit other than the structural unit represented by Formula (1) above. The p-PPS typically contains 99 mass% or greater of the structural unit represented by Formula (1) above with respect to the mass of one molecule of the p-PPS.

The weight average molecular weight of the p-PPS is preferably 1000 or greater and 100000 or less. When the weight average molecular weight of the p-PPS is 1000 or greater, the strength of a molded article (e.g., vibration damping material) made of the resin composition is high. When the weight average molecular weight of the p-PPS is 100000 or less, the moldability of the resin composition is especially good. The weight average molecular weight of the p-PPS is a value measured by using gel permeation chromatography (GPC), calibrated with polystyrene. Specifically, the weight average molecular weight is measured by the following method. In 10 g of 1-chloronaphthalene, 10 mg of p-PPS is dissolved at 230° C. The prepared solution is subjected to hot filtration by using a membrane filter and cooled to room temperature. By using a 2 µL aliquot of sample taken from the resultant solution, the weight average molecular weight was measured by high-temperature GPC in conditions of a column temperature of 250° C., a solvent of 1-chloronaphthalene, and a flow rate of 0.7 mL/min.

The glass transition temperature of the p-PPS is preferably 80° C. or higher and 100° C. or lower. When the glass transition temperature of the p-PPS is in the range described above, a resin composition having excellent processability and heat resistance tends to be produced.

The melting point of the p-PPS is preferably 270° C. or higher and 300° C. or lower. When the melting point of the p-PPS is 270° C. or higher, a resin composition having excellent heat resistance tends to be produced. On the other hand, when the melting point of the p-PPS is 300° C. or lower, melt-kneading with the m-PPS described below can be performed without excessively increasing the temperature. The glass transition temperature and melting point of the p-PPS can be measured by differential scanning calorimetry (DSC). Specifically, first, p-PPS is pressed and molded at 320° C., and then the resultant molded article is rapidly cooled to room temperature. A 5 mg aliquot of the p-PPS is taken from the cooled molded article. The 5 mg of the p-PPS is sealed in an aluminum pan to prepare a measurement sample. The measurement sample is heated from the room temperature to 340° C., and during this time, a DSC curve is formed. The temperature increasing rate from 50° C. to 340° C. is 10° C./min. Based on the formed DSC curve, the glass transition temperature and melting point are determined.

The preparation method of the p-PPS is not particularly limited. For example, the p-PPS is produced by a known method in which p-dichlorobenzene having two halogens at the para-position and a sulfur source containing an alkali metal are polymerized in an organic amide solvent. The preparation method of the p-PPS is not limited to this method.

### Poly(m-Phenylene Sulfide) (m-PPS)

The m-PPS is a resin containing a structural unit represented by Formula (2) below.

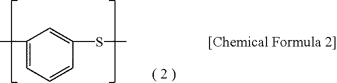

In a range that does not impair the desired effects, the m-PPS may further partially contain a structural unit other than the structural unit represented by Formula (2) above. The m-PPS typically contains 99 mass% or greater of the structural unit represented by Formula (2) above with respect to the mass of one molecule of the m-PPS.

The weight average molecular weight of the m-PPS is preferably 3000 or greater and 9000 or less. When the weight average molecular weight of the m-PPS is 3000 or greater, the strength of a molded article (e.g., vibration damping material) made of the resin composition is high. When the weight average molecular weight of the m-PPS is 9000 or less, it is easier for the m-PPS to get into crystals of the p-PPS. As a result, a desired improvement effect of the loss factor at 100° C. or lower is readily achieved. The weight average molecular weight of the m-PPS is a value measured by using gel permeation chromatography (GPC), calibrated with polystyrene. The specific measurement method is the same as the measurement method of the weight average molecular weight of the p-PPS described above.

The glass transition temperature of the m-PPS is preferably room temperature or lower. Specifically, the glass transition temperature of the m-PPS may be 25° C. or lower, 20° C. or lower, or 15° C. or lower. When the glass transition temperature of the m-PPS is in the temperature range described above, a resin composition having excellent processability and heat resistance tends to be produced.

The melting point of the m-PPS is typically not observed. The glass transition temperature and melting point of the m-PPS can be measured by differential scanning calorimetry (DSC). The measurement methods are the same as the measurement methods of the glass transition temperature and melting point of the p-PPS described above.

The preparation method of the m-PPS is not particularly limited. For example, the m-PPS is produced by a known method in which m-dichlorobenzene having two halogens at meta positions and a sulfur source containing an alkali metal are polymerized in an organic amide solvent. However, the preparation method of the m-PPS is not limited to this method.

### Physical Property of Resin Composition

The resin composition may contain another component besides the p-PPS and the m-PPS described above in a range that does not impair the desired effect. However, the total amount of the p-PPS and the m-PPS is preferably 20 mass% or greater, and more preferably 40 mass% or greater, with respect to the total mass of the resin composition.

Typical examples of the other component include thermoplastic resins other than the p-PPS and the m-PPS.

Preferred examples in a case where the other resin is a thermoplastic resin include polyacetal resins, polyamide resins, polycarbonate resins, polyester resins (e.g., polybutylene terephthalate, polyethylene terephthalate, polyarylate resins, and liquid crystalline polyester resins), FR-AS resins, FR-ABS resins, AS resins, ABS resins, polyphenylene oxide resins, polyarylene sulfide resins other than the p-PPS and the m-PPS, polysulfone resins, polyether sulfone resins, polyether ether ketone resins, fluorine-based resins, polyimide resins, polyamide-imide resins, polyamide bismaleimide resins, polyetherimide resins, polybenzoxazole resins, polybenzothiazole resins, polybenzimidazole resins, BT resins, polymethylpentene, ultra high molecular weight polyethylene, FR-polypropylene, and polystyrene.

Among such other resins described above, from the perspectives of ease in mixing the p-PPS and the m-PPS and vibration damping properties of the resin composition, polyarylene sulfide resins other than the p-PPS and the m-PPS are preferred. Among the polyarylene sulfide resins other than the p-PPS and the m-PPS, from the perspective of vibration damping properties of the resin composition, a halogenated polyphenylene sulfide resin is preferred. The halogenated polyphenylene sulfide resin is a polycondensation product of a halogenated benzene and an alkali metal sulfide. The halogenated benzene is a dihalobenzene and/or a trihalobenzene. The ratio of the mass of the trihalobenzene to the mass of the halogenated benzene is 50 mass% or greater.

The halogenated benzene contains from one to three types of halogen atoms selected from the group consisting of a fluorine atom, a chlorine atom, a bromine atom, and an iodine atom.

From the perspectives of the polycondensation reactivity of the halogenated benzene and easy availability of the halogenated benzene, the halogen atom of the halogenated benzene is preferably a chlorine atom. That is, as the halogenated benzene, dichlorobenzene and trichlorobenzene are preferred.

The halogenated polyphenylene sulfide resin is not limited to a straight-chain polymer in which a halophenylene group or a phenylene group and a sulfur atom are alternately bonded. Typically, the halogenated polyphenylene sulfide resin contains a branched structure in which all three halogen atoms contained in the trihalobenzene have been reacted with alkali metal sulfides.

Preferred specific examples of the trihalobenzene include 1,2,3-trichlorobenzene, 1,2,4-trichlorobenzene, and 1,3,5-trichlorobenzene. Among these, from the perspective of reactivity in the polycondensation, 1,2,4-trichlorobenzene is preferred. Thus, the trihalobenzene preferably contains 1,2,4-trichlorobenzene, and more preferably, all of the trihalobenzene is 1,2,4-trichlorobenzene.

The ratio of the mass of 1,2,4-trichlorobenzene to the mass of the trihalobenzene in a case where the trihalobenzene contains the 1,2,4-trichlorobenzene is preferably 70 mass% or greater, more preferably 80 mass% or greater, even more preferably 90 mass% or greater, yet even more preferably 95 mass% or greater, and most preferably 100 mass%.

Preferred specific examples of the dihalobenzene include p-dichlorobenzene, m-dichlorobenzene, and o-dichlorobenzene. Among these, from the perspectives of easy availability, low cost, excellent processability and mechanical properties of the resulting halogenated polyphenylene sulfide resin, and the like, p-dichlorobenzene is preferred.

Note that, depending on the production method, the trihalobenzene may contain a dihalobenzene as an impurity. Such a trihalobenzene containing a dihalobenzene as an impurity can be preferably used as a raw material for the halogenated poly(phenylene sulfide).

In this case, in the trihalobenzene containing a dihalobenzene as an impurity, the purity of the trihalobenzene is preferably 90 mass% or greater and 99.9 mass% or less and the content of the dihalobenzene is preferably 0.1 mass% or greater and 10 mass% or less, and the purity of the trihalobenzene is more preferably 95 mass% or greater and 99.9 mass% or less and the content of the dihalobenzene is more preferably 0.1 mass% or greater and 95 mass% or less.

From the perspective of excellent vibration damping performance, the ratio of the mass of the trichlorobenzene to the total of the mass of the trichlorobenzene and the mass of the dichlorobenzene used in the production of the halogenated polyphenylene sulfide resin is preferably 70 mass% or greater, more preferably 90 mass% or greater, and even more preferably 100 mass%.

Examples of the alkali metal sulfides include lithium sulfide, sodium sulfide, potassium sulfide, rubidium sulfide, and cesium sulfide. Among these, sodium sulfide and potassium sulfide are preferred, and sodium sulfide is more preferred. The alkali metal sulfide as a sulfur source can be handled in a form of, for example, an aqueous slurry or an aqueous solution.

The method of polycondensation reaction of the halogenated benzene and the alkali metal sulfide is not particularly limited, and a method that is the same as or similar to known production methods of polyarylene sulfide can be appropriately employed.

An example of the preferred method includes a method in which a halogenated benzene and an alkali metal sulfide are heated and polymerized in the presence of a solvent.

The content ratio (mass ratio) of the p-PPS and the m-PPS in the resin composition is appropriately selected based on the desired physical properties. When the content proportion of the m-PPS is increased, the loss factor at 50° C. of the resin composition and loss factors at 50 to 100° C. tend to increase. On the other hand, when the content proportion of the p-PPS is increased, moldability of the resin composition tends to be good.

For example, in a case where high moldability is required for the resin composition, the amount of the m-PPS with respect to the total amount of the p-PPS and the m-PPS is preferably 1 mass% or greater and 50 mass% or less. The amount of the m-PPS is more preferably 3 mass% or greater and 40 mass% or less, and even more preferably 5 mass% or greater and 30 mass% or less.

In a case where high vibration damping properties are required for the resin composition, the amount of the m-PPS with respect to the total amount of the p-PPS and the m-PPS is preferably greater than 50 mass% and 90 mass% or less. The amount of the m-PPS is more preferably 55 mass% or greater and 85 mass% or less, and even more preferably 60 mass% or greater and 80 mass% or less.

The content ratio (mass ratio) of the p-PPS and the m-PPS may be identified based on the charged amounts. Note that, whether the resin composition contains p-PPS and m-PPS can be determined by, for example, comparing the glass transition temperature of the resin composition with the glass transition temperature of the p-PPS alone or the glass transition temperature of the m-PPS alone.

The loss factor at 50° C. of the resin composition is preferably 0.03 or greater. When the loss factor at 50° C. is 0.03 or greater, the resin composition has sufficient vibration damping properties even at approximately 50° C. Thus, the resin composition having a loss factor at 50° C. of 0.03 or greater can be applied to a vibration damping material used in an environment at approximately 50° C.

Furthermore, the average value of the loss factors at 50° C. to 100° C. is preferably 0.06 or greater. When the average value of the loss factors at 50° C. to 100° C. is 0.06 or greater, sufficiently high vibration damping properties are exhibited in the range. Note that the average value of the loss factors at 50° C. to 100° C. is an average value of six loss factors at 50° C., 60° C., 70° C., 80° C., 90° C., and 100° C.

The loss factor can be calculated as described below. First, a resin composition is compression-molded, and thus a pressed sheet having a thickness of 1 mm is produced. Specifically, compression in conditions at 320° C. and 5 MPa for 1 minute is performed, then compression in conditions at 150° C. and 10 MPa for 3 minutes is performed, and thus the pressed sheet is produced. From the pressed sheet produced by the compression molding, a 10 mm × 5 mm × 1 mm strip sample is cut. Then, the strip sample is subjected to annealing treatment at 150° C. for 1 hour. For this sheet, by using a dynamic viscoelastic measurement device, a storage elastic modulus (E′) and a loss elastic modulus (E″) are measured every 10° C. at a frequency of 10 Hz while the temperature is changed from 20° C. to 240° C. at a temperature increasing rate of 2° C./min in the tensile mode. Based on the storage elastic modulus (E′) and the loss elastic modulus (E″) at 50° C., the loss factor at 50° C. is determined. Also, the average value of the loss factors at six points total, which are at 50° C., 60° C., 70° C., 80° C., 90° C., and 100° C., is calculated.

### Preparation Method of Resin Composition

The preparation method of the resin composition is not particularly limited as long as the method can prepare a resin composition containing the p-PPS and the m-PPS in a desired ratio. An example of the preparation method of the resin composition includes a method in which the p-PPS and the m-PPS and other optional raw materials are adequately mixed by melt-kneading.

The mixing method by melt-kneading is not particularly limited. First, the p-PPS and the m-PPS and other optional raw materials are premixed by a mixer, such as a Henschel mixer or a tumbler. The premixed mixture is kneaded by using a single or twin screw extruder and extruded to be formed into a desired shape. Examples of the shape of the resin composition include a pellet shape or a sheet shape. Furthermore, the kneading may be performed by forming a masterbatch using some of the p-PPS or the m-PPS and then mixing with the rest of the components. Furthermore, to enhance dispersibility of the p-PPS and the m-PPS, after the preparation of the p-PPS and the m-PPS, these may be pulverized to a desired particle size and then mixed or melt-kneaded.

The temperature at the time of melt-kneading is preferably 280° C. or higher and 320° C. or lower, and more preferably 300° C. or higher and 320° C. or lower. When the temperature at the time of melt-kneading is 280° C. or higher, the p-PPS and the m-PPS are each adequately melted and easily uniformly mixed. When the temperature at the time of melt-kneading is 320° C. or lower, while decomposition of the p-PPS and the m-PPS is suppressed, the p-PPS and the m-PPS can be kneaded.

### Use of Resin Composition

As described above, the resin composition can be suitably used as a vibration damping material. The vibration damping material is only required to contain the resin composition described above. However, to enhance the strength of the vibration damping material or to enhance the moldability, fillers may be mixed in the resin composition as the vibration damping material. The vibration damping material may also contain various additives as needed.

Examples of the fillers include: fibrous fillers such as glass fibers, carbon fibers, silicon carbide fibers, silica fibers, alumina fibers, zirconia fibers, and aramid fibers; whiskers such as potassium titanate whiskers, calcium silicate whiskers (wollastonite), calcium sulfate whiskers, carbon whiskers, and boron whiskers; and powder inorganic fillers of talc, mica, kaolin, clay, glass, magnesium carbonate, magnesium phosphate, calcium carbonate, calcium silicate, calcium sulfate, calcium phosphate, silicon oxide, aluminum oxide, titanium oxide, iron oxide (including ferrite), copper oxide, zirconia, zinc oxide, silicon carbide, carbon, graphite, boron nitride, molybdenum disulfide, or silicon. The vibration damping material may contain only one type of filler or may contain two or more types of fillers.

The shape of the fillers is not particularly limited and may be spherical, plate-like, or fibrous. The dimension, such as a particle size, a fiber diameter, or a fiber length, of the fillers is appropriately selected based on, for example, the use of the vibration damping material and the required strength.

The amount of the fillers is preferably 0.1 parts by mass or greater and 400 parts by mass or less, and more preferably 1 part by mass or greater and 300 parts by mass or less, with respect to 100 parts by mass of the resin composition. When the amount of the fillers is 0.1 parts by mass or greater, the strength of the vibration damping material or the moldability can be enhanced. On the other hand, when the amount of the fillers is 400 parts by mass or less, the performances originated from the resin composition (e.g., vibration damping properties) are less likely to be lost.

The vibration damping material in which the fillers and the resin composition are mixed can be prepared by, for example, kneading the resin composition and the fillers by melt-kneading.

### Molded Article

The resin composition or the vibration damping material described above can be suitably used by being formed into molded articles having various shapes by an appropriate method.

The resin composition or the vibration damping material is typically formed into a molded article by an ordinary method, such as press molding, extrusion molding, or injection molding.

The use of the molded article is not particularly limited. Specific examples of the use of the molded article include: components of devices generating vibration, such as transport vehicles including vehicles such as automobiles and two-wheeled vehicles, ships, railways, and aircraft, or peripheral components of the devices; components of devices for which reduction of vibration is desired, such as seats and peripheral components of seats, and controls of the transport vehicles; various household electrical appliance components; office automation equipment components; construction materials; machine tool components; and industrial machine components.

Among the use described above, examples of use of a molded article include components of coolant circulation devices in transport vehicles having engines, such as automobiles. Examples of the components of a coolant circulation device include pump housings and pipes for coolant circulation.

By using the molded article for the use described above, various products can be made vibration-damping.

### EXAMPLES

The present invention will be described in further detail below with reference to examples. The scope of the present invention is not to be construed as being limited by these examples.

### Preparation Example 1

In an autoclave having a volume of 1 L and equipped with an agitator, 78.0 g of sodium sulfide, 2.5 g of sodium hydroxide, 374.8 g of N-methyl-2-pyrrolidone (NMP), 27.0 g of ion-exchanged water, and 195.4 g of 1,2,4-trichlorobenzene (purity: 99.8 mass%) were charged. Then, inside of the autoclave was purged with a nitrogen gas atmosphere, and the autoclave was sealed. Thereafter, while the reaction solution in the autoclave was agitated, the reaction solution was heated gradually to 240° C. over approximately 30 minutes. After the polycondensation reaction was performed by maintaining 240° C. for 2 hours, the reaction solution was cooled to approximately room temperature.

After the contents of the autoclave were taken out, 1 L of acetone containing 3 mass% of pure water was added to the contents of the autoclave, and the contents were washed at room temperature for 30 minutes by agitation. After the washed solid contents (crude article) were recovered by filtration, the washing operation by acetone described above was repeated for twice.

The solid contents washed by the acetone were washed in 1 L of pure water at room temperature for 30 minutes by agitation, and then recovered by filtration. The recovered solid contents were repeatedly subjected to the washing operation by the pure water described above for three times, then the solid contents recovered by the filtration were dried at 120° C. for 4 hours, and thus a polycondensation product of trichlorobenzene and sodium sulfide was produced as a purified halogenated polyphenylene sulfide resin. The resultant halogenated polyphenylene sulfide resin in Preparation Example 1 is also indicated as CI-PPS.

The weight average molecular weight (Mw) of the resultant CI-PPS was 3500. The weight average molecular weight (Mw) was measured in accordance with the method described above.

### Examples 1 to 6

### Preparation of m-PPS

In a 1 L autoclave equipped with an agitator, 78.0 g of sodium sulfide, 2.5 g of sodium hydroxide, 374.8 g of N-methyl-2-pyrrolidone (NMP), 27.0 g of ion-exchanged water, and 149.9 g of 1,3-dichlorobenzene were charged. The autoclave was sealed in a nitrogen gas, heated gradually to 240° C. over approximately 30 minutes while agitation was performed, and maintained for 2 hours. Thereafter, the contents that had been cooled to approximately room temperature were taken out. Then, 1 L of acetone containing 3 mass% of pure water was added to the contents and agitated at room temperature for 30 minutes. Then, after operation of filtering the solid contents was performed for three times, 1 L of pure water was further added. After the agitation for 30 minutes at room temperature, operation of filtration was performed once. 1 L of 0.18 mass% acetic acid aqueous solution was further added and, after the agitation for 30 minutes at room temperature, operation of filtration was performed once. Thereafter, 1 L of pure water was added and, after the agitation for 20 minutes at room temperature, operation of filtration was performed for 4 times. The resultant solid contents were dried by hot air at 120° C. for 4 hours, and thus m-PPS was produced. The weight average molecular weight (Mw) of the resultant m-PPS was 5000.

The weight average molecular weight (Mw) was measured in accordance with the method described above.

### Melt Kneading

In Examples 1 to 5, p-PPS (W-214A, available from Kureha Corporation; weight average molecular weight: 48500) and the m-PPS described above were dry-blended in the ratio listed in Table 1. Note that the weight average molecular weight of the p-PPS was measured in the same manner as for the m-PPS.

In Example 6, p-PPS (W-214A, available from Kureha Corporation; weight average molecular weight: 48500), the m-PPS, and the Cl-PPS produced in Preparation Example 1 were dry-blended in the ratio listed in Table 1. Thereafter, melt-kneading was performed by using LABO PLASTOMILL (available from Toyo Seiki Seisaku-sho, Ltd.) equipped with an R60 (volume: 60 mL) barrel and a full flight screw. The melt-kneading by the LABO PLASTOMILL was performed in the conditions at a temperature of 320° C., time of 5 minutes, and rotational speed of 100 rpm. The resultant resin composition was compressed at 320° C., at 5 MPa, for 1 minute and then compressed at 150° C., at 10 MPa, for 3 minutes, and thus a 55 mm × 55 mm × 1 mm pressed sheet was produced.

### Comparative Example 1

Although it was attempted to form the m-PPS alone into a sheet shape without melt-kneading with p-PPS, a pressed sheet that can stand on its own could not be produced.

### Comparative Example 2

A pressed sheet was produced in the same manner as in Example 1 and the like by using only p-PPS.

### Comparative Example 3

A pressed sheet was produced in the same manner as in Example 1 except for using polycarbonate (lupilon HL-3003, available from Mitsubishi Engineering-Plastics Corporation) in place of the m-PPS.

### Evaluation

For each of the produced resin compositions, the loss factor and moldability were evaluated by the following methods.

### Loss Factor

From the pressed sheet, a 10 mm × 5 mm × 1 mm strip sample was cut out by using a box-cutter. The produced sample was subjected to annealing treatment at 150° C. for 1 hour. For the sample, a storage elastic modulus (E′) and a loss elastic modulus (E″) were measured every 10° C. at a frequency of 10 Hz while the temperature was increased from 20° C. to 240° C. at a temperature increasing rate of 2° C./min in the tensile mode. Based on the storage elastic modulus (E′) and the loss elastic modulus (E″) at 50° C., the loss factor at 50° C. was determined. Also, the average value of the loss factors at six points total, which were at 50° C., 60° C., 70° C., 80° C., 90° C., and 100° C., was determined. The results are shown in Table 1.

### Moldability

The moldability of the pressed sheet was evaluated. The evaluation criteria are as follows.
Excellent: Superior
Good: A pressed sheet was molded; however, the produced pressed sheet was brittle to the degree that the pressed sheet cracked easily by bending.
Poor: Molding was not possible.

[TABLE 1]

| | Examples | | | | | | Comparative Examples | | |
|---|---|---|---|---|---|---|---|---|---|
| | 1 | 2 | 3 | 4 | 5 | 6 | 1 | 2 | 3 |
| p-PPS (Mw = 48500) | 90 | 80 | 50 | 20 | 95 | 80 | 0 | 100 | 90 |
| m-PPS (Mw = 5000) | 10 | 20 | 50 | 80 | 5 | 10 | 100 | 0 | 0 |
| Cl-PPS (Mw = 3500) | 0 | 0 | 0 | 0 | 0 | 10 | 0 | 0 | 0 |
| Polycarbonate | 0 | 0 | 0 | 0 | 0 | 0 | 0 | 0 | 10 |
| Loss factor (50° C.) | 0.037 | 0.058 | 0.112 | 0.241 | 0.028 | 0.025 | Not determined | 0.009 | 0.007 |
| Average value of loss factors at 50 to 100° C. | 0.073 | 0.081 | 0.115 | 0.160 | 0.065 | 0.072 | Not determined | 0.018 | 0.008 |
| Moldability | Excellent | Excellent | Good | Good | Excellent | Excellent | Poor | Excellent | Excellent |

As is clear from Table 1 above, the loss factors at 50° C. of the resin compositions of Examples 1 to 6, which contained the p-PPS and the m-PPS, were equivalent to or better than the loss factor of the p-PPS alone of Comparative Example 2. Furthermore, regarding the average value of the loss factors at 50 to 100° C., the values for the resin compositions of Examples 1 to 6 were greater than the value for the p-PPS alone of Comparative Example 2. Meanwhile, when the m-PPS alone of Comparative Example 1 was used, molding of a pressed sheet failed, and the loss factors could not be measured. Furthermore, a larger amount of the poly(m-phenylene sulfide) tended to increase the loss factors but also tended to decrease the moldability. Furthermore, the resin composition of Comparative Example 3, in which polycarbonate was used in place of the m-PPS, had a low loss factor at 50° C. and also had a low average value of loss factors at 50 to 100° C.

1. A vibration damping material comprising:
a poly(phenylene sulfide) resin composition comprising
poly(p-phenylene sulfide), and
poly(m-phenylene sulfide).

2. The vibration damping material according to claim 1, wherein
a loss factor at 50° C. of the poly(phenylene sulfide) resin composition is 0.03 or greater, and
an average value of loss factors at 50° C. to 100° C. of the poly(phenylene sulfide) resin composition is 0.06 or greater.

3. The vibration damping material according to claim 1, wherein, in the poly(phenylene sulfide) resin composition, a ratio of a mass of the poly(m-phenylene sulfide) to a total of a mass of the poly(p-phenylene sulfide) and the mass of the poly(m-phenylene sulfide) is 1 mass% or greater and 50 mass% or less.

4. The vibration damping material according to claim 1, wherein, in the poly(phenylene sulfide) resin composition, a ratio of a mass of the poly(m-phenylene sulfide) to a total of a mass of the poly(p-phenylene sulfide) and the mass of the poly(m-phenylene sulfide) is greater than 50 mass% and 90 mass% or less.

5. (canceled)

6. A molded article comprising:
the vibration damping material described in claim 1.
